(19) United States
(12) Patent Application Publication
(10) Pub. No.: US 2025/0076055 A1
(43) Pub. Date: Mar. 6, 2025

(54) INERTIAL MEASUREMENT DEVICE AND METHOD FOR MANUFACTURING INERTIAL MEASUREMENT DEVICE

(71) Applicant: SEIKO EPSON CORPORATION, Tokyo (JP)

(72) Inventors: Yoshiyuki Matsuura, Shiojiri-shi (JP); Ryohei Ozawa, Shiojiri-shi (JP)

(21) Appl. No.: 18/819,205

(22) Filed: Aug. 29, 2024

(30) Foreign Application Priority Data
Aug. 31, 2023 (JP) 2023-141175

(51) Int. Cl. G01C 19/5783

(52) U.S. Cl. CPC G01C 19/5783

(57) ABSTRACT

An inertial measurement device includes: a sensor substrate including a substrate having a first surface and a first side surface, and a first inertial sensor arranged on the first side surface; a case housing the sensor substrate; a first partition arranged in the case and forming a first space that surrounds the first inertial sensor in the case; and a first filling member filling the first space and covering the first inertial sensor.

The present application is based on, and claims priority from JP Application Serial Number 2023-141175, filed Aug. 31, 2023, the disclosure of which is hereby incorporated by reference herein in its entirety.

### BACKGROUND

### 1. Technical Field

The present disclosure relates to an inertial measurement device and a method for manufacturing an inertial measurement device.

### 2. Related Art

An inertial measurement device described in JP-A-2017-20829 includes an inner case, a substrate mounted on a lower surface of the inner case, a Z-axis angular velocity sensor and an acceleration sensor mounted on an upper surface of the substrate, an X-axis angular velocity sensor and a Y-axis angular velocity sensor mounted on a side surface of the substrate, and an outer case that covers the inner case to house the substrate between the inner case and the outer case.

Further, a recess is formed in the lower surface of the inner case, and the X-axis angular velocity sensor, the Y-axis angular velocity sensor, the Z-axis angular velocity sensor, and the acceleration sensors are arranged at positions overlapping the recess. In addition, the recess is filled with a filling member, the Z-axis angular velocity sensor and the acceleration sensor are entirely sealed with the filling member, and the upper halves of the X-axis angular velocity sensor and the Y-axis angular velocity sensor are sealed.

In the inertial measurement device of JP-A-2017-20829, the filling member is provided to reduce an influence of noise vibration from the outside and improve stability of detection accuracy.

However, in the inertial measurement device of JP-A-2017-20829, only the upper halves of the X-axis angular velocity sensor and the Y-axis angular velocity sensor are sealed with a sealing member. Therefore, stress is applied to the X-axis angular velocity sensor and the Y-axis angular velocity sensor in an unbalanced manner, resulting in a problem of deterioration of detection characteristics.

### SUMMARY

According to an aspect of the present disclosure, an inertial measurement device includes: a sensor substrate including a substrate having a first surface and a first side surface, and a first inertial sensor arranged on the first side surface; a case housing the sensor substrate; a first partition arranged in the case and forming a first space that surrounds the first inertial sensor in the case; and a first filling member filling the first space and covering the first inertial sensor.

According to another aspect of the present disclosure, a method for manufacturing an inertial measurement device includes: a first filling step of filling a recess of a first case with a bottom-side filling member; a sensor substrate mounting step of mounting, in the recess, a sensor substrate including a substrate having a first surface and a first side surface and a first inertial sensor arranged on the first side surface; a first partition arrangement step of arranging a first partition in the recess and forming a first space that surrounds the first inertial sensor in the first case; a second filling step of filling the first space with an opening-side filling member to cover the first inertial sensor; a filling member hardening step of hardening the bottom-side filling member and the opening-side filling member to form a first filling member that covers the first inertial sensor; and a case attachment step of attaching a second case to the first case in such a way as to close the recess.

### BRIEF DESCRIPTION OF THE DRAWINGS

FIG. 1 is a top view illustrating an inertial measurement device according to a first embodiment.

FIG. 2 is an exploded perspective view of the inertial measurement device.

FIG. 3 is a cross-sectional view taken along line III-III in FIG. 1.

FIG. 4 is a cross-sectional view taken along line IV-IV in FIG. 1.

FIG. 5 is a top view of an inner case.

FIG. 6 is a plan view illustrating an angular velocity sensor.

FIG. 7 is a schematic diagram illustrating a driving state of the angular velocity sensor.

FIG. 8 is a schematic diagram illustrating a driving state of the angular velocity sensor.

FIG. 9 is a flowchart illustrating a method for manufacturing the inertial measurement device.

FIG. 10 is a cross-sectional view for describing the method for manufacturing the inertial measurement device.

FIG. 11 is a cross-sectional view for describing the method for manufacturing the inertial measurement device.

FIG. 12 is a cross-sectional view for describing the method for manufacturing the inertial measurement device.

FIG. 13 is a cross-sectional view for describing the method for manufacturing the inertial measurement device.

FIG. 14 is a cross-sectional view for describing the method for manufacturing the inertial measurement device.

FIG. 15 is a cross-sectional view for describing the method for manufacturing the inertial measurement device.

FIG. 16 is a cross-sectional view for describing the method for manufacturing the inertial measurement device.

FIG. 17 is a top view illustrating an inertial measurement device according to a second embodiment.

FIG. 18 is an exploded perspective view of the inertial measurement device.

FIG. 19 is a cross-sectional view taken along line XIX-XIX in FIG. 17.

FIG. 20 is a cross-sectional view taken along line XX-XX in FIG. 17.

FIG. 21 is an exploded perspective view of an inertial measurement device according to a third embodiment.

FIG. 22 is a cross-sectional view of the inertial measurement device.

### DESCRIPTION OF EMBODIMENTS

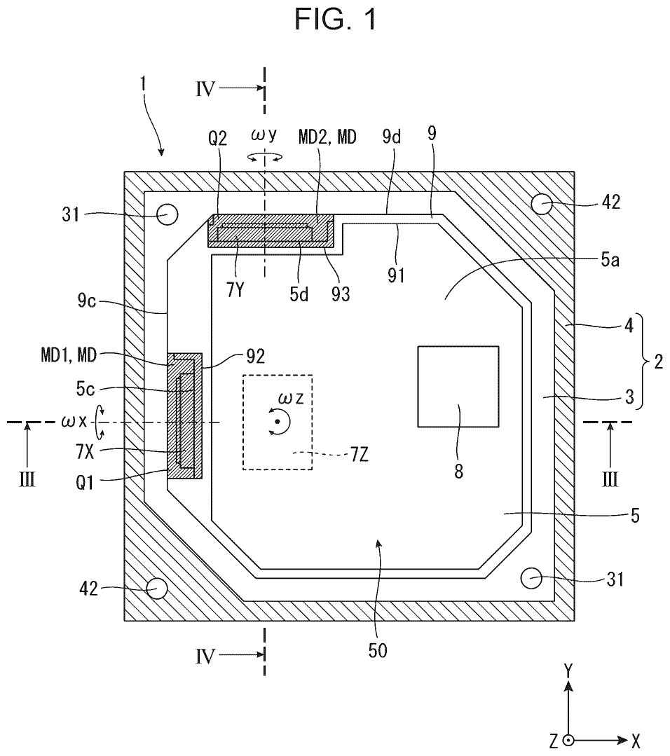

Hereinafter, an inertial measurement device and a method for manufacturing an inertial measurement unit according to the present disclosure will be described in detail based on embodiments illustrated in the accompanying drawings. For convenience of explanation, three mutually orthogonal axes are illustrated as an X axis, a Y axis, and a Z axis in FIGS. 1 to 5 and 10 to 16. Hereinafter, for convenience of explanation, a direction parallel to the X axis is referred to as an “X-axis direction”, a direction parallel to the Y axis is referred to as a “Y-axis direction”, and a direction parallel to the Z axis is referred to as a “Z-axis direction”. An arrow side of the Z-axis direction is referred to as an “upper side” and a side opposite thereto is referred to as a “lower side”.

### First Embodiment

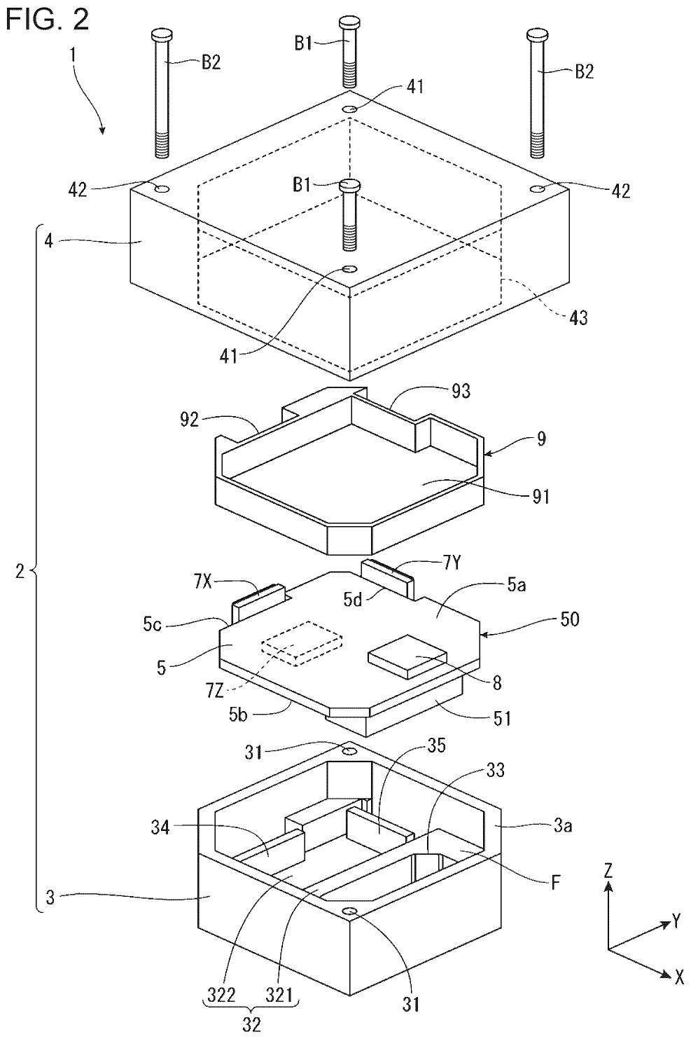

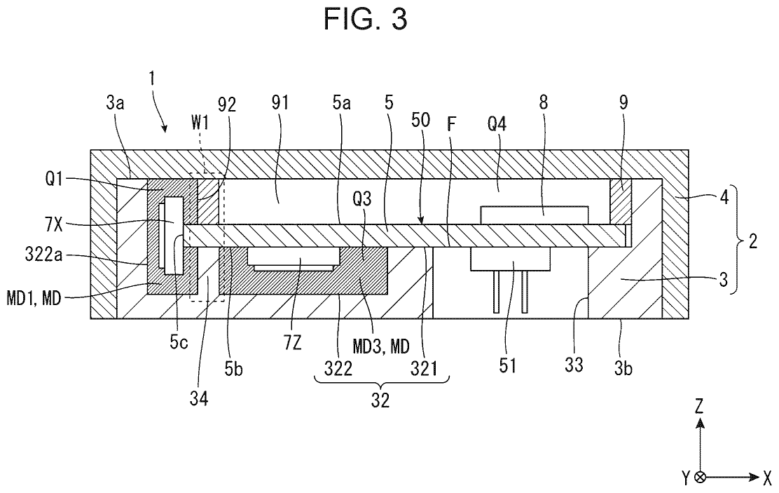

FIG. 1 is a top view illustrating an inertial measurement device according to a first embodiment. FIG. 2 is an exploded perspective view of the inertial measurement device. FIG. 3 is a cross-sectional view taken along line

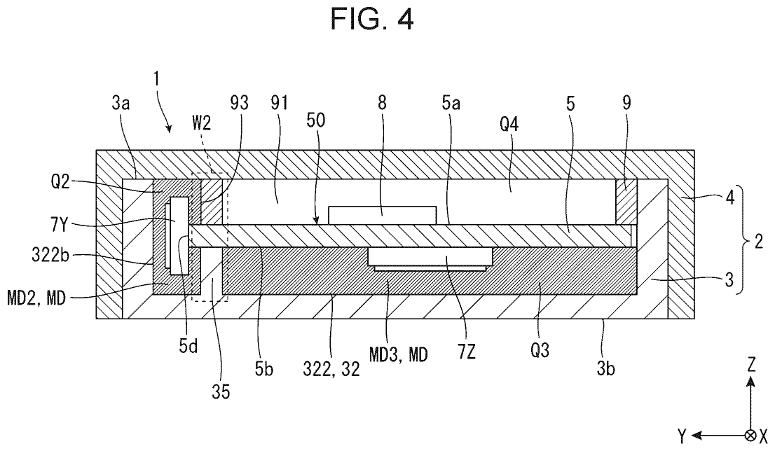

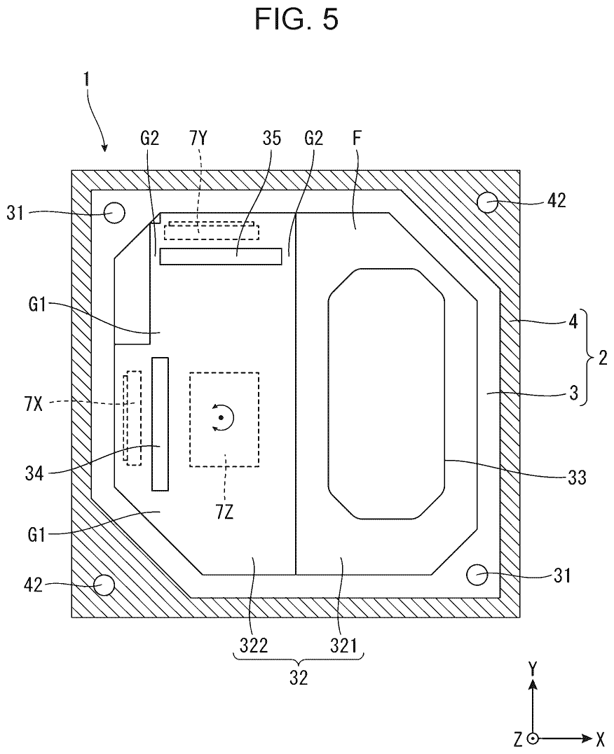

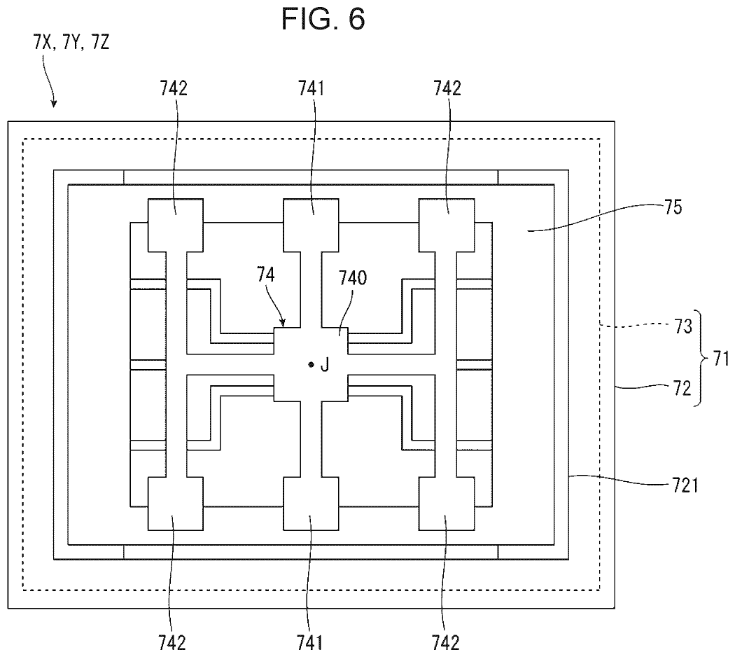

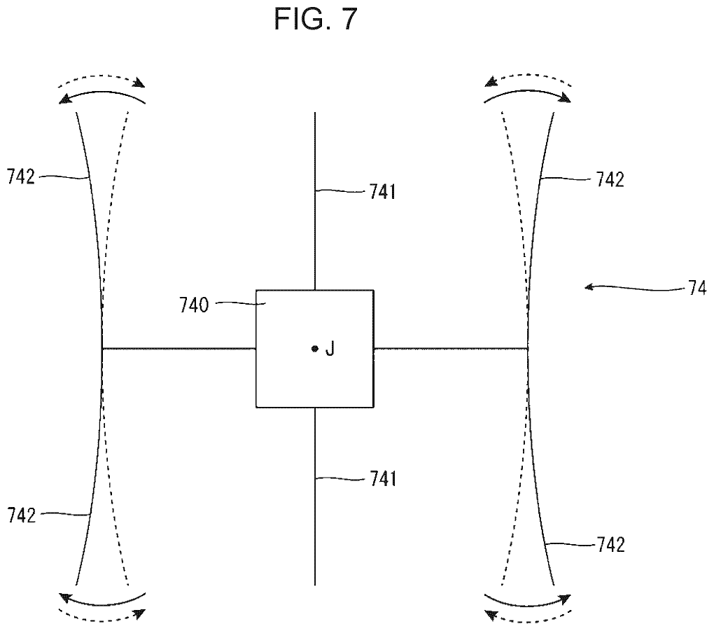

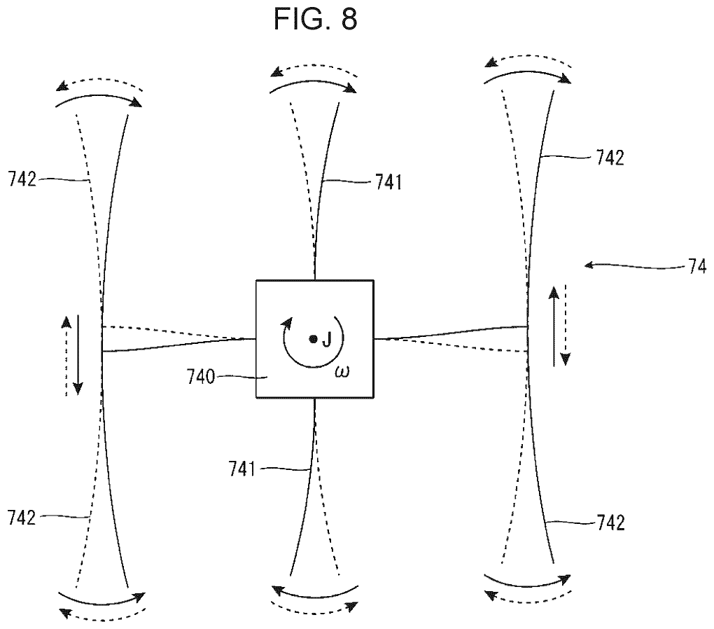

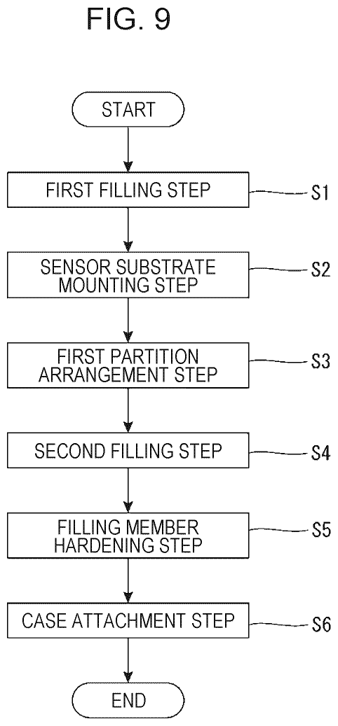

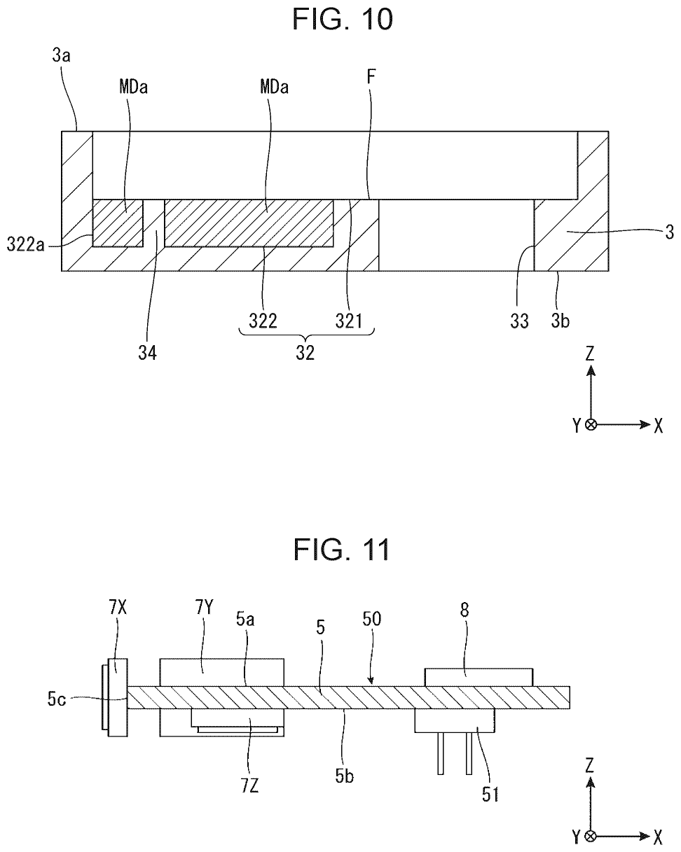

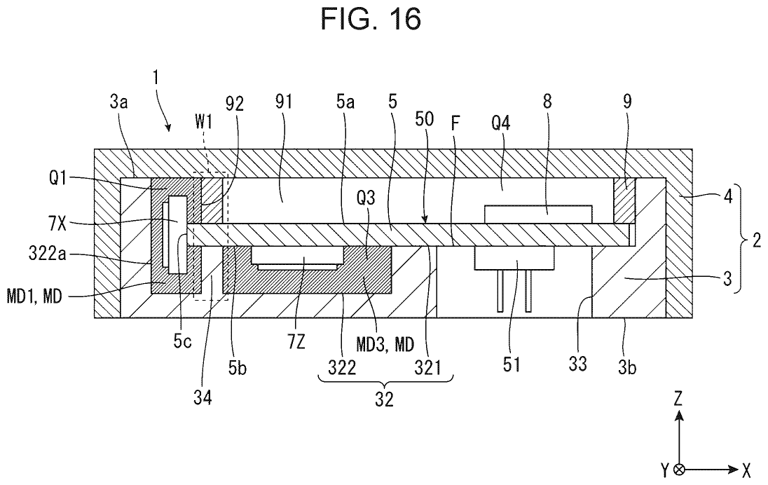

III-III in FIG. 1. FIG. 4 is a cross-sectional view taken along line IV-IV in FIG. 1. FIG. 5 is a top view of an inner case. FIG. 6 is a plan view illustrating an angular velocity sensor. FIGS. 7 and 8 are schematic diagrams each illustrating a driving state of the angular velocity sensor. FIG. 9 is a flowchart illustrating a method for manufacturing the inertial measurement device. FIGS. 10 and 16 are cross-sectional views for describing the method for manufacturing the inertial measurement device.

An inertial measurement device 1 illustrated in FIG. 1 is an inertial measurement unit (IMU) that detects a posture and a behavior of a mounted object such as an automobile or robot. The mounted object is not limited to moving bodies such as an automobile and a robot, and may be, for example, a structure such as a bridge, an elevated structure, or a track. When the inertial measurement device 1 is attached to a structure, the inertial measurement device 1 is used as a structural health monitoring system that checks soundness of the structure.

As illustrated in FIGS. 1 and 2, the inertial measurement device 1 includes a case 2, a sensor substrate 50 housed in the case 2, and a first partition 9 housed in the case 2 and arranged on the sensor substrate 50. The sensor substrate 50 includes a substrate 5, an X-axis angular velocity sensor 7X serving as a first inertial sensor, a Y-axis angular velocity sensor 7Y serving as a second inertial sensor, a Z-axis angular velocity sensor 7z serving as a third inertial sensor, and a circuit element 8 serving as an electronic component, the X-axis angular velocity sensor 7X, the Y-axis angular velocity sensor 7Y, the Z-axis angular velocity sensor 7Z, and the circuit element 8 being mounted on the substrate 5. These components will be described in order below.

### Case 2

As illustrated in FIGS. 1 and 2, the case 2 includes an inner case 3 serving as a first case and an outer case 4 serving as a second case that covers the inner case 3. The inner case 3 and the outer case 4 are each made of aluminum. Therefore, the case 2 has a sufficiently high rigidity. In particular, in the present embodiment, surfaces of the inner case 3 and the outer case 4 are each anodized to provide insulation to the case 2. However, materials of the inner case 3 and the outer case 4 are not particularly limited, and may be metal materials such as titanium, magnesium, and stainless steel, or ceramics such as alumina and titania.

The inner case 3 has a box shape whose upper side is opened, and has a rectangular parallelepiped shape of which two corners positioned on one diagonal line are chamfered. In addition, screw holes 31 for fixing the outer case 4 are formed at two corners positioned on the other diagonal line of the inner case 3.

As illustrated in FIGS. 3 to 5, the inner case 3 has a recess 32 that is open on an upper surface 3a. The recess 32 includes a first recess 321 that is open on the upper surface 3a, and a second recess 322 that is open on a bottom surface of the first recess 321 and has a smaller opening than the first recess 321. The inner case 3 has a through-hole 33 that penetrates through a lower surface 3b and the bottom surface of the first recess 321. The through-hole 33 is a hole for exposing a connector 51 described below to the outside.

The inner case 3 includes a second partition 34 and a third partition 35 arranged on a bottom surface of the second recess 322. The second and third partitions 34 and 35 are protrusions that protrude upward from the bottom surface of the second recess 322, and are formed integrally with the inner case 3. Therefore, it is easy to form the second partition 34 and the third partition 35. Further, a mechanical strength of each of the second partition 34 and the third partition 35 is sufficiently high. However, the second partition 34 and the third partition 35 are not limited thereto, and the second partition 34 and the third partition 35 may be formed separately from the inner case 3.

As illustrated in FIG. 3, the second partition 34 faces an inner peripheral surface 322a positioned on a negative side of the second recess 322 in the X-axis direction at a distance, and extends straight in the Y-axis direction. As illustrated in FIG. 5, both end portions of the second partition 34 are spaced apart from the inner peripheral surface of the second recess 322, and a gap G1 is formed between the both end portions of the second partition 34 and the inner peripheral surface of the second recess 322. On the other hand, as illustrated in FIG. 4, the third partition 35 faces an inner peripheral surface 322b positioned on a positive side of the second recess 322 in the Y-axis direction at a distance, and extends straight in the X-axis direction. As illustrated in FIG. 5, both end portions of the third partition 35 are spaced apart from the inner peripheral surface of the second recess 322, and a gap G2 is formed between the both end portions of the third partition 35 and the inner peripheral surface of the second recess 322.

As illustrated in FIGS. 3 and 4, upper surfaces of the second partition 34 and the third partition 35 are flush with the bottom surface of the first recess 321. Each of the upper surfaces of the second partition 34 and the third partition 35 functions as a mounting surface F on which the substrate 5 is mounted, together with the bottom surface of the first recess 321.

As illustrated in FIG. 2, the outer case 4 has a box shape whose lower side is opened, and has a rectangular parallelepiped shape. The outer case 4 covers the inner case 3 from above by inserting the inner case 3 into a recess 43 that is open on a lower surface of the outer case 4. An opening shape of the outer case 4 matches an outer shape of the inner case 3. Therefore, the outer case 4 is prevented from rattling with respect to the inner case 3. In addition, screw holes 41 that overlap the screw holes 31 are formed at two corners positioned on one diagonal line of the outer case 4. The inner case 3 and the outer case 4 are fixed by mounting screws B1 inserted through the screw holes 31 and 41. However, a method for fixing the outer case 4 to the inner case 3 is not particularly limited. Further, screw holes 42 are formed at two corners positioned on the other diagonal line of the outer case 4. Then, the inertial measurement device 1 is mounted on the mounted object by mounting screws B2 inserted through the two screw holes 42. However, a method for mounting the inertial measurement device 1 to the mounted object is not particularly limited. Substrate 5

The substrate 5 is a circuit board, and is implemented by, for example, a multi-layer glass epoxy substrate. However, a configuration of the substrate 5 is not particularly limited, and the substrate 5 may be, for example, a multi-layer ceramic substrate. As illustrated in FIG. 2, the substrate 5 has an upper surface 5a serving as a first surface and a lower surface 5b serving as a second surface, which are in a front-back relationship with each other. The substrate 5 also has side surfaces connecting the upper surface 5a and the lower surface 5b, and the side surfaces include a first side surface 5c facing a negative side in the X-axis direction and a second side surface 5d facing a positive side in the Y-axis direction. The substrate 5 having such a configuration is housed in the recess 32 of the inner case 3. As illustrated in FIGS. 3 and 4, the substrate 5 is mounted on the mounting surface F of the inner case 3 with the upper surface 5a facing upward.

As illustrated in FIG. 3, the connector 51 is provided on the lower surface 5b of the substrate 5. The connector 51 is a plug-type connector and is exposed to the outside of the inertial measurement device 1 through the through-hole 33 formed in the inner case 3. As a result, electrical connection between the inertial measurement device 1 and an external device is facilitated. Furthermore, the X-axis angular velocity sensor 7X, the Y-axis angular velocity sensor 7Y, the Z-axis angular velocity sensor 7Z, and the circuit element 8 are mounted on the substrate 5.

### X-Axis Angular Velocity Sensor 7X, Y-Axis Angular Velocity Sensors 7Y, and Z-Axis Angular Velocity Sensor 7Z

As illustrated in FIG. 3, the X-axis angular velocity sensor 7X is mounted on the first side surface 5c of the substrate 5 in such a way as to face the negative side in the X-axis direction. The X-axis angular velocity sensor 7X is longer than the substrate 5 in the Z-axis direction and protrudes upward and downward from the substrate 5. A lower end portion of the X-axis angular velocity sensor 7X (a portion positioned lower than the substrate 5) is inserted between the second partition 34 and the inner peripheral surface 322a. Such an X-axis angular velocity sensor 7X detects an angular velocity ox around the X axis.

As illustrated in FIG. 4, the Y-axis angular velocity sensor 7Y is mounted on the second side surface 5d of the substrate 5 in such a way as to face the positive side in the Y-axis direction. The Y-axis angular velocity sensor 7Y is longer than the substrate 5 in the Z-axis direction and protrudes upward and downward from the substrate 5. A lower end portion of the Y-axis angular velocity sensor 7Y (a portion positioned lower than the substrate 5) is inserted between the third partition 35 and the inner peripheral surface 322b. Such a Y-axis angular velocity sensor 7Y detects an angular velocity ωy around the Y axis.

As illustrated in FIGS. 3 and 4, the Z-axis angular velocity sensor 7Z is mounted on the lower surface 5b of the substrate 5 in such a way as to face downward. The Z-axis angular velocity sensor 7Z is also inserted between the second partition 34 and the third partition 35. Such a Z-axis angular velocity sensor 7Z detects an angular velocity ωz around the Z axis.

Each of the X-axis angular velocity sensor 7X, the Y-axis angular velocity sensor 7Y, and the Z-axis angular velocity sensor 7Z is a packaged surface-mounted component. Therefore, the X-axis angular velocity sensor 7X, the Y-axis angular velocity sensor 7Y, and the Z-axis angular velocity sensor 7Z may have a higher mechanical strength than those of components with exposed elements. Furthermore, it is easier to mount the X-axis angular velocity sensor 7X, the Y-axis angular velocity sensor 7Y, and the Z-axis angular velocity sensor 7Z on the substrate 5.

The X-axis angular velocity sensor 7X, the Y-axis angular velocity sensor 7Y, and the Z-axis angular velocity sensor 7Z have the same basic configuration, except that vibration frequencies of sensor elements 74 described below are different from each other to suppress an interference among the X-axis angular velocity sensor 7X, the Y-axis angular velocity sensor 7Y, and the Z-axis angular velocity sensor 7Z, and the X-axis angular velocity sensor 7X, the Y-axis angular velocity sensor 7Y, and the Z-axis angular velocity sensor 7Z are arranged orthogonal to each other in such a way that detection axes thereof face the X axis, the Y axis and the Z axis, respectively.

As illustrated in FIG. 6, each of the X-axis angular velocity sensor 7X, the Y-axis angular velocity sensor 7Y, and the Z-axis angular velocity sensor 7Z includes a package 71 and the sensor element 74 housed in the package 71. The package 71 also includes a box-shaped base 72 having a recess 721 and supporting the sensor element 74 housed in the recess 721, and a lid 73 bonded to the base 72 in such a way as to close an opening of the recess 721. A connection terminal (not illustrated) electrically connected to the sensor element 74 is formed on the base 72, and electrical connection to the substrate 5 is made via the connection terminal.

The sensor element 74 is, for example, a quartz crystal vibration element having drive vibration arms and detection vibration arms. In the illustrated configuration, the sensor element 74 includes a base portion 740 fixed to the base 72 via a support substrate 75, four drive vibration arms 742, and two detection vibration arms 741. In such a quartz crystal vibration element, when an angular velocity @ around a detection axis J is applied in a state in which the drive vibration arms 742 are driven to vibrate according to an applied drive signal as illustrated in FIG. 7, the detection vibration is excited in the detection vibration arms 741 by the Coriolis force as illustrated in FIG. 8. Then, a charge generated in the detection vibration arms 741 by the detection vibration is extracted as a detection signal, and the angular velocity @ can be obtained based on the extracted detection signal.

The configurations of the X-axis angular velocity sensor 7X, the Y-axis angular velocity sensor 7Y, and the Z-axis angular velocity sensor 7Z have been described above. The X-axis angular velocity sensor 7X is arranged in such a way that the detection axis J is along the X axis, the Y-axis angular velocity sensor 7Y is arranged in such a way that the detection axis J is along the Y axis, and the Z-axis angular velocity sensor 7Z is arranged in such a way that the detection axis J is along the Z axis.

However, the configurations of the X-axis angular velocity sensor 7X, the Y-axis angular velocity sensor 7Y, and the Z-axis angular velocity sensor 7Z are not particularly limited. For example, a silicon micro-electromechanical systems (MEMS) vibration element may be used as the sensor element.

### Circuit Element 8

As illustrated in FIGS. 3 and 4, the circuit element 8 is mounted on the upper surface 5a of the substrate 5. The circuit element 8 is electrically connected to the X-axis angular velocity sensor 7X, the Y-axis angular velocity sensor 7Y, and the Z-axis angular velocity sensor 7Z via the substrate 5. Such a circuit element 8 is, for example, a micro controller unit (MCU), and controls each part of the inertial measurement device 1. Specifically, the circuit element 8 includes a control circuit that controls the driving of the X-axis angular velocity sensor 7X, the Y-axis angular velocity sensor 7Y, and the Z-axis angular velocity sensor 7Z, and an interface circuit that communicates with the outside.

The control circuit independently controls the driving of the X-axis angular velocity sensor 7X, the Y-axis angular velocity sensor 7Y, and the Z-axis angular velocity sensor 7Z, and independently detects an angular velocity around each of the X axis, the Y axis, and the Z axis based on the detection signals output from the X-axis angular velocity sensor 7X, the Y-axis angular velocity sensor 7Y, and the Z-axis angular velocity sensor 7Z. The interface circuit transmits and receives a signal to receive a command from an external device and output the detected angular velocity and acceleration to an external device. A communication method of the interface circuit is not particularly limited, but the communication method of the interface circuit may be serial peripheral interface (SPI) communication in the present embodiment. The SPI communication is a communication method suitable for connecting a plurality of sensors. Since all signals related to the angular velocity and the acceleration can be output from one pin, it is possible to reduce the number of pins of the inertial measurement device 1.

In addition to the X-axis angular velocity sensor 7X, the Y-axis angular velocity sensor 7Y, the Z-axis angular velocity sensor 7Z, and the circuit element 8 described above, a plurality of electronic components are mounted on the substrate 5, but the electronic components will not be illustrated and described for convenience of explanation.

### First Partition 9

As illustrated in FIGS. 3 and 4, the first partition 9 is housed in the recess 32 of the inner case 3 together with the substrate 5. The first partition 9 is positioned on an upper side of the substrate 5 and mounted on the upper surface 5a. In addition, an upper surface of the first partition 9 is in contact with a bottom surface of the recess 43 of the outer case 4. Therefore, the substrate 5 and the first partition 9 are sandwiched between the inner case 3 and the outer case 4, so that rattling of the substrate 5 and the first partition 9 within the case 2 can be suppressed. In addition, an outer shape of the first partition 9 matches a shape of the recess 32 of the inner case 3. Therefore, rattling of the first partition 9 with respect to the inner case 3 is suppressed.

Such a first partition 9 is made of aluminum. Therefore, the case 2 has a sufficiently high rigidity. In particular, in the present embodiment, a surface of the first partition 9 is anodized to provide insulation. As the first partition 9 is made of the same material as the inner case 3 and the outer case 4, it is possible to make thermal expansion coefficients thereof equal to each other. However, the materials of the inner case 3 and the outer case 4 are not particularly limited, and may be metal materials such as titanium, magnesium, and stainless steel, or ceramics such as alumina and titania.

As illustrated in FIG. 1, the first partition 9 has a frame shape in plan view when viewed from the Z-axis direction. That is, the first partition 9 has a through-hole 91 penetrating through the upper and lower surfaces of the first partition 9. The circuit element 8 is arranged in the through-hole 91. The first partition 9 has an outer side surface 9c facing the negative side in the X-axis direction, and a recess 92 is formed in the outer side surface 9c. The first partition 9 has an outer side surface 9d facing the positive side in the Y-axis direction, and a recess 93 is formed in the outer side surface 9d. The recesses 92 and 93 are cutout holes that are open on the outer side surfaces of the first partition 9 and penetrate through the upper and lower surfaces of the first partition 9. The upper half of the X-axis angular velocity sensor 7X is arranged in the recess 92, and the upper half of the Y-axis angular velocity sensor 7Y is arranged in the recess 93.

The recess 92 in FIG. 3 has a cross-sectional structure that is symmetrical with respect to the second partition 34 and the substrate 5. Therefore, it is possible to make stress applied to the X-axis angular velocity sensor 7X by a first filling member MD1 around the X-axis angular velocity sensor 7X uniform. Similarly, the recess 93 in FIG. 4 has a cross-sectional structure symmetrical with respect to the third partition 35 and the substrate 5. Therefore, it is possible to make stress applied to the Y-axis angular velocity sensor 7Y by a second filling member MD2 around the Y-axis angular velocity sensor 7Y uniform.

In the inertial measurement device 1 as described above, a first space Q1, a second space Q2, a third space Q3, and a fourth space Q4 are formed in the case 2 by the substrate 5, the first partition 9, the second partition 34, and the third partition 35.

As illustrated in FIG. 3, the first space Q1 is formed in the case 2 by a wall portion W1 formed by the recess 92 of the first partition 9, the substrate 5, and the second partition 34, and extending in a straight line from a bottom surface of the recess 32 to the opening. With such a configuration, the first space Q1 can be easily formed. The X-axis angular velocity sensor 7X is arranged in the first space Q1.

As illustrated in FIG. 4, the second space Q2 is formed in the case 2 by a wall portion W2 formed by the recess 93 of the first partition 9, the substrate 5, and the third partition 35, and extending in a straight line from the bottom surface of the recess 32 to the opening. With such a configuration, the second space Q2 can be easily formed. The Y-axis angular velocity sensor 7Y is arranged in the second space Q2.

As illustrated in FIG. 3 and FIG. 4, the third space Q3 is formed in the case 2 by the substrate 5 and the second and third partitions 34 and 35. With such a configuration, the third space Q3 can be easily formed. The third space Q3 is positioned on a side of the second partition 34 that is opposite to the first space Q1, and on a side of the third partition 35 that is opposite to the second space Q2. In other words, the third space Q3 is aligned with the first space Q1 in the X-axis direction across the second partition 34, and aligned with the second space Q2 in the Y-axis direction across the third partition 35. The Z-axis angular velocity sensor 7Z is arranged in the third space Q3. As illustrated in FIG. 3 and FIG. 4, the fourth space Q4 is formed in the case 2 by the substrate 5 and the through-hole 91 of the first partition 9. The circuit element 8 is arranged in the fourth space Q4.

The first space Q1, the second space Q2, and the third space Q3 are not completely independent of one another, but communicate with one another through the gaps G1 and G2. As the gaps G1 and G2 are provided in this way, an unhardened filling member MD flows across the first space Q1, the second space Q2, and the third space Q3 when manufacturing the inertial measurement device 1 as described below, which makes it easier to fill the filling member MD and simplifies the manufacturing of the inertial measurement device 1. However, the present disclosure is not limited thereto, and the gaps G1 and G2 may be eliminated, and the first space Q1, the second space Q2, and the third space Q3 may be independent of each other. In contrast, the fourth space Q4 is independent and isolated from the first space Q1, the second space Q2, and the third space Q3. Therefore, it is possible to effectively prevent the filling member MD from entering the fourth space Q4.

As illustrated in FIGS. 3 and 4, the first space Q1, the second space Q2, and the third space Q3 are each filled with the filling member MD. Specifically, the first space Q1 is filled with the first filling member MD1, the second space Q2 is filled with the second filling member MD2, and the third space Q3 is filled with a third filling member MD3. In contrast, the fourth space Q4 is not filled with the filling member MD, and is hollow.

The first filling member MD1 fills the inside of the first space Q1, and covers the entire X-axis angular velocity sensor 7X arranged in the first space Q1. Similarly, the second filling member MD2 fills the inside of the second space Q2, and covers the entire Y-axis angular velocity sensor 7Y arranged in the second space Q2. The third filling member MD3 fills the inside of the third space Q3, and covers the entire Z-axis angular velocity sensor 7Z arranged in the third space Q3.

A material that is hard, has a low hygroscopicity, and has a small thermal expansion coefficient is suitable for the filling member MD. In the present embodiment, a thermosetting epoxy adhesive is used as the filling member MD. Therefore, the filling member MD has the above-described characteristics in a well-balanced manner. A hardness of the filling member MD after hardening is not particularly limited, and may be 80 D or more or 90 D or more when measured with a type D durometer in a durometer hardness test of JIS 7215-1986. In addition, various fillers may be included in the epoxy adhesive. As a result, it is possible to easily adjust the hardness and the thermal expansion coefficient.

In this way, the X-axis angular velocity sensor 7X is housed in the first space Q1 formed by the wall portion W1 and the inner case, and a structure in which a gap between the X-axis angular velocity sensor 7X and the first space Q1 is filled with the first filling member MD1 makes it possible to significantly reduce the amount of filling member around the X-axis angular velocity sensor 7X. Therefore, it is possible to effectively prevent moisture and humidity from intruding into the first filling member MD1 and the X-axis angular velocity sensor 7X. In addition, for example, even when the first filling member MD1 absorbs moisture and expands, stress is more uniformly applied to the X-axis angular velocity sensor 7X from a periphery thereof as compared to a configuration in which the X-axis angular velocity sensor 7X is partially exposed from the filling member MD as in the related art, so that fluctuations in detection characteristic can be suppressed. The same effect can also be achieved by covering the entire Y-axis angular velocity sensor 7Y with the second filling member MD2 and covering the entire Z-axis angular velocity sensor 7Z with the third filling member MD3. Therefore, it is possible to provide the inertial measurement device 1 having a high moisture resistance and high detection accuracy.

The inertial measurement device 1 has been described above. Next, a method for manufacturing the inertial measurement device 1 will be described. As illustrated in FIG. 9, the method for manufacturing the inertial measurement device 1 includes a first filling step S1 of filling the recess 32 of the inner case 3 with a bottom-side filling member MDa, a sensor substrate mounting step S2 of mounting the sensor substrate 50 in the recess 32, a first partition arrangement step S3 of arranging the first partition 9 in the recess 32, a second filling step S4 of filling the recess 32 with an opening-side filling member MDb, a filling member hardening step S5 of hardening the bottom-side filling member MDa and the opening-side filling member MDb, and a case attachment step S6 of attaching the outer case 4 to the inner case 3. In the following, the manufacturing method will be described using the cross-sectional view taken along line III-III in FIG. 1, and some members will be described but not illustrated in the drawing.

### First Filling Step S1

In the first filling step S1, the second recess 322 of the inner case 3 is filled with the bottom-side filling member MDa as illustrated in FIG. 10. At this time, the bottom-side filling member MDa flows around back sides of the second and third partitions 34 and 35 through the gaps G1 and G2, so that the entire second recess 322 can be filled with the bottom-side filling member MDa without excess or deficiency. Therefore, occurrence of voids can be effectively suppressed. Although not illustrated, the bottom-side filling member MDa is also applied to the mounting surface F. The bottom-side filling member MDa applied to the mounting surface F functions as an adhesive for bonding the sensor substrate 50 to the mounting surface F.

### Sensor Substrate Mounting Step S2

In the sensor substrate mounting step S2, first, the substrate 5 on which the X-axis angular velocity sensor 7X, the Y-axis angular velocity sensor 7Y, the Z-axis angular velocity sensor 7Z, and the circuit element 8 are mounted, that is, the sensor substrate 50, is prepared as illustrated in FIG. 11.

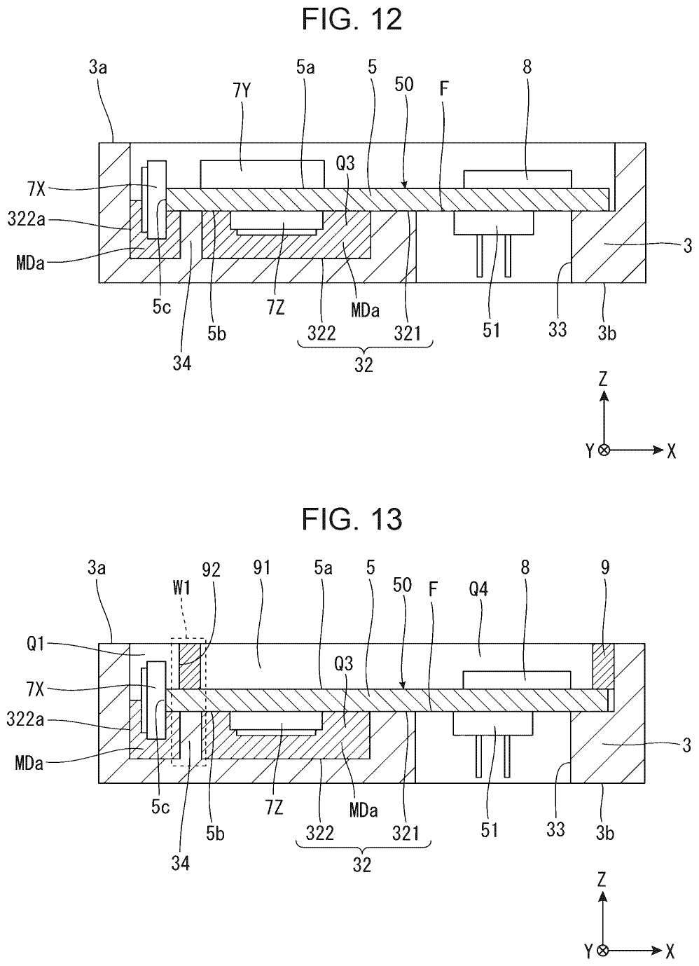

Next, as illustrated in FIG. 12, the sensor substrate 50 is inserted into the recess 32 and mounted on the mounting surface F. As a result, the sensor substrate 50 is housed in the inner case 3. In addition, the third space Q3 is formed between the sensor substrate 50 and the inner case 3 by the second and third partitions 34 and 35, and the entire Z-axis angular velocity sensor 7Z is embedded in the bottom-side filling member MDa filling the third space Q3. In addition, the lower halves of the X-axis angular velocity sensor 7X and the Y-axis angular velocity sensor 7Y are embedded in the bottom-side filling member MDa.

### First Partition Arrangement Step S3

In the first partition arrangement step S3, the first partition 9 is inserted into the recess 32 and mounted on an upper surface of the sensor substrate 50 as illustrated in FIG. 13. As a result, the first partition 9 is housed in the inner case 3. In addition, the wall portions W1 and W2 are formed in the inner case 3, thereby forming the first space Q1, the second space Q2, and the fourth space Q4 in the inner case 3.

### Second Filling Step S4

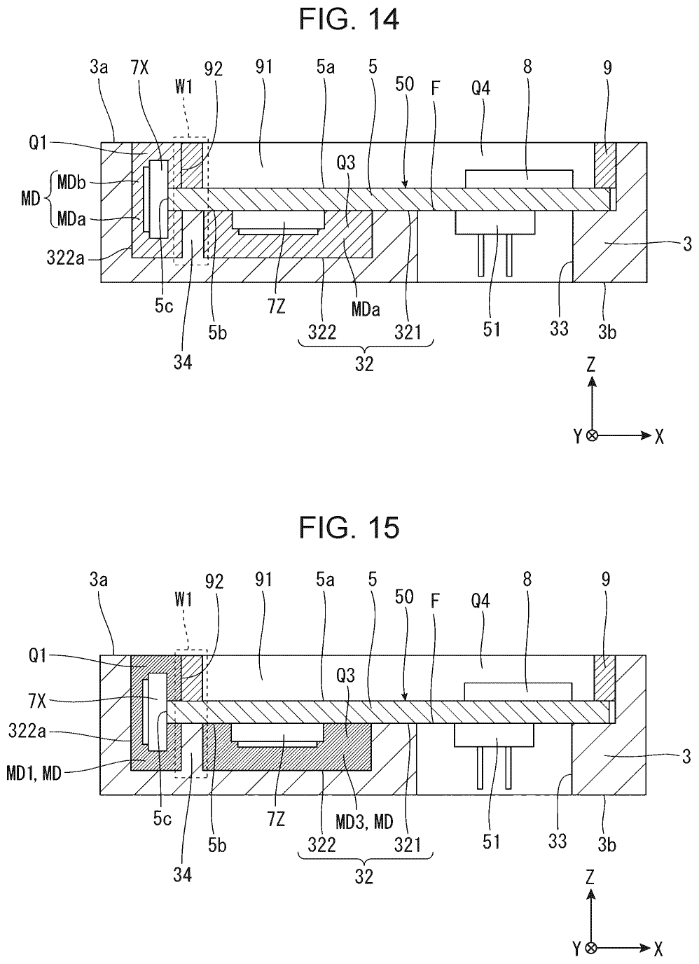

In the second filling step S4, the first and second spaces Q1 and Q2 are filled with the unhardened opening-side filling member MDb through the recesses 92 and 93 as illustrated in FIG. 14. As a result, the upper halves of the X-axis angular velocity sensor 7X and the Y-axis angular velocity sensor 7Y are embedded in the opening-side filling member MDb, and as a result, the entire X-axis angular velocity sensor 7X and the entire Y-axis angular velocity sensor 7Y are embedded in the filling member MD including the bottom-side filling member MDa and the opening-side filling member MDb. The step S4 is performed before the bottom-side filling member MDa filled in the first filling step S1 is hardened. As a result, the bottom-side filling member MDa and the opening-side filling member MDb are integrated, and no boundary is generated between the bottom-side filling member MDa and the opening-side filling member MDb when being hardened, so that stress applied to the periphery of the X-axis angular velocity sensor 7X and the Y-axis angular velocity sensor 7Y can be made uniform. Filling Member Hardening Step S5

In the filling member hardening step S5, the filling member MD is hardened by heating as illustrated in FIG. 15. As a result, the first filling member MD1 that covers the entire X-axis angular velocity sensor 7X, the second filling member MD2 that covers the entire Y-axis angular velocity sensor 7Y, and the third filling member MD3 that covers the entire Z-axis angular velocity sensor 7Z are formed. A method for hardening the filling member MD is not particularly limited.

### Case Attachment Step S6

In the case attachment step S6, the outer case 4 covers the inner case 3 as illustrated in FIG. 16. Then, the mounting screws B1 are inserted into the screw holes 31 and 41 to fix the inner case 3 and the outer case 4.

The inertial measurement device 1 is obtained as described above. According to the method for manufacturing the inertial measurement device 1, the inertial measurement device 1 in which the entire X-axis angular velocity sensor 7X, the Y-axis angular velocity sensor 7Y, and the Z-axis angular velocity sensor 7Z are entirely sealed with the filling member MD can be manufactured by a simple process.

The method for manufacturing the inertial measurement device 1 is not particularly limited, and for example, the order of the filling member hardening step S5 and the case attachment step S6 may be reversed. In other words, the filling member MD may be hardened after the outer case 4 is attached. With such a method, the filling member MD can be hardened in a state in which the substrate 5 and first partition 9 are sandwiched between the outer case 4 and the inner case 3, so that displacement of the substrate 5 and first partition 9 due to stress generated during hardening can be effectively suppressed.

The inertial measurement device 1 and the method for manufacturing the inertial measurement device 1 according to the present embodiment have been described above. As described above, the inertial measurement device 1 includes the sensor substrate 50 including the substrate 5 having the upper surface 5a serving as the first surface and the first side surface 5c, and the X-axis angular velocity sensor 7X serving as the first inertial sensor arranged on the first side surface 5c, the case 2 housing the sensor substrate 50, the first partition 9 arranged in the case 2 and forming the first space Q1 that surrounds the X-axis angular velocity sensor 7X in the case 2, and the first filling member MD1 filling the first space Q1 and covering the X-axis angular velocity sensor 7X. With such a configuration, the amount of filling member around the X-axis angular velocity sensor 7X can be significantly reduced, and it is possible to effectively prevent moisture and humidity from intruding into the first filling member MD1 and the X-axis angular velocity sensor 7X. In addition, for example, even when the first filling member MD1 absorbs moisture and expands, stress is more uniformly applied to the X-axis angular velocity sensor 7X from the periphery thereof as compared to a configuration in which the X-axis angular velocity sensor 7X is partially exposed from the first filling member MD1 as in the related art, so that fluctuations in detection characteristic can be suppressed.

As described above, the substrate 5 has the lower surface 5b serving as the second surface that is in a front-back relationship with the upper surface 5a. The inertial measurement device 1 includes the second partition 34 arranged between the lower surface 5b and the case 2. The first space Q1 is formed by the first partition 9, the substrate 5, and the second partition 34. With such a configuration, the first space Q1 can be easily formed.

As described above, the second partition 34 is a protrusion that protrudes from the inner surface of the case 2 toward the substrate 5. In other words, the second partition 34 is formed integrally with the case 2. Therefore, it becomes easy to form the second partition 34. The mechanical strength of the second partition 34 can also be increased.

As described above, the substrate 5 has the second side surface 5d that is different from the first side surface 5c. The sensor substrate 50 includes the Y-axis angular velocity sensor 7Y serving as the second inertial sensor arranged on the second side surface 5d. The first partition 9 forms the second space Q2 that surrounds the Y-axis angular velocity sensor 7Y. The inertial measurement device 1 includes the second filling member MD2 that fills the second space Q2 and covers the Y-axis angular velocity sensor 7Y. With such a configuration, the amount of filling member around the Y-axis angular velocity sensor 7Y can be significantly reduced, and it is possible to effectively prevent moisture and humidity from intruding into the second filling member MD2 and the Y-axis angular velocity sensor 7Y. In addition, for example, even when the second filling member MD2 absorbs moisture and expands, stress is more uniformly applied to the Y-axis angular velocity sensor 7Y from the periphery thereof as compared to a configuration in which the Y-axis angular velocity sensor 7Y is partially exposed from the second filling member MD2 as in the related art, so that fluctuations in detection characteristic can be suppressed.

As described above, the inertial measurement device 1 includes the third partition 35 arranged between the lower surface 5b and the case 2. The second space Q2 is formed by the first partition 9, the substrate 5, and the third partition 35. With such a configuration, the second space Q2 can be easily formed.

As described above, the third partition 35 is a protrusion that protrudes from the inner surface of the case 2 toward the substrate 5. In other words, the third partition 35 is formed integrally with the case 2. Therefore, it becomes easy to form the third partition 35. The mechanical strength of the third partition 35 can also be increased.

As described above, the sensor substrate 50 includes the Z-axis angular velocity sensor 7Z serving as the third inertial sensor arranged on the lower surface 5b. Furthermore, the substrate 5, the second partition 34, and the third partition 35 form the third space Q3 that surrounds the Z-axis angular velocity sensor 7Z in the case 2. The inertial measurement device 1 includes the third filling member MD3 that fills the third space Q3 and covers the Z-axis angular velocity sensor 7Z. With such a configuration, the amount of filling member around the Z-axis angular velocity sensor 7Z can be significantly reduced, and it is possible to effectively prevent moisture and humidity from intruding into the third filling member MD3 and the Z-axis angular velocity sensor 7Z. In addition, for example, even when the third filling member MD3 absorbs moisture and expands, stress is uniformly applied to the Z-axis angular velocity sensor 7Z from a periphery thereof, so that fluctuations in detection characteristic can be suppressed.

Furthermore, as described above, the first space Q1, the second space Q2, and the third space Q3 mutually communicate with one another. With such a configuration, the unhardened filling member MD can flow across each of the spaces Q1, Q2, and Q3, and the filling member MD can uniformly fill each of the spaces Q1, Q2, and Q3 when manufacturing the inertial measurement device 1. Therefore, an effect of suppressing occurrence of voids in each of the spaces Q1, Q2, and Q3 can be expected.

As described above, the sensor substrate 50 includes the circuit element 8 serving as the electronic component arranged on the upper surface 5a. The first partition 9 forms the fourth space Q4 in the case 2 that is isolated from the first space Q1 and surrounds the circuit element 8. Therefore, it is possible to effectively prevent the filling member MD from entering the fourth space Q4.

As described above, the method for manufacturing the inertial measurement device 1 includes the first filling step S1 of filling the recess 32 of the inner case 3 serving as the first case with the bottom-side filling member MDa, the sensor substrate mounting step S2 of mounting, in the recess 32, the sensor substrate 50 including the substrate 5 having the upper surface 5a serving as the first surface and the first side surface 5c and the X-axis angular velocity sensor 7X serving as the first inertial sensor arranged on the first side surface 5c, the first partition arrangement step S3 of arranging the first partition 9 in the recess 32 and forming the first space Q1 that surrounds the X-axis angular velocity sensor 7X in the inner case 3, the second filling step S4 of filling the first space Q1 with the opening-side filling member MDb to cover the X-axis angular velocity sensor 7X, the filling member hardening step S5 of hardening the bottom-side filling member MDa and the opening-side filling member MDb to form the first filling member MD1 that covers the X-axis angular velocity sensor 7X, and the case attachment step S6 of attaching the outer case 4 serving as the second case to the inner case 3 in such a way as to close the recess 32. With such a manufacturing method, it is possible to easily form the inertial measurement device 1 in which the space Q1 having a significantly small volume surrounds the X-axis angular velocity sensor 7X and the gap therebetween is filled with the first filling member MD1. Therefore, it is possible to effectively prevent intrusion of moisture and humidity into the first filling member MD1 around the X-axis angular velocity sensor 7X and the X-axis angular velocity sensor 7X. In addition, for example, even when the first filling member MD1 absorbs moisture and expands, stress is more uniformly applied to the X-axis angular velocity sensor 7X from the periphery thereof as compared to a configuration in which the X-axis angular velocity sensor 7X is partially exposed from the first filling member MD1 as in the related art, so that fluctuations in detection characteristic can be suppressed.

As described above, the sensor substrate 50 includes the Y-axis angular velocity sensor 7Y serving as the second inertial sensor arranged on the second side surface 5d different from the first side surface 5c of the substrate 5. In the first partition arrangement step S3, the first partition 9 is arranged to form the second space Q2 that surrounds the Y-axis angular velocity sensor 7Y in the inner case 3, in the second filling step S4, the opening-side filling member MDb fills the second space Q2 to cover the Y-axis angular velocity sensor 7Y, and in the filling member hardening step S5, the bottom-side filling member MDa and the opening-side filling member MDb are hardened to form the second filling member MD2 that covers the Y-axis angular velocity sensor 7Y. With such a manufacturing method, it is possible to easily form the inertial measurement device 1 in which the space Q2 having a significantly small volume surrounds the Y-axis angular velocity sensor 7Y and the gap therebetween is filled with the second filling member MD2. Therefore, it is possible to effectively prevent intrusion of moisture and humidity into the second filling member MD2 around the Y-axis angular velocity sensor 7Y and the Y-axis angular velocity sensor 7Y. In addition, for example, even when the second filling member MD2 absorbs moisture and expands, stress is more uniformly applied to the Y-axis angular velocity sensor 7Y from the periphery thereof as compared to a configuration in which the Y-axis angular velocity sensor 7Y is partially exposed from the second filling member MD2 as in the related art, so that fluctuations in detection characteristic can be suppressed.

### Second Embodiment

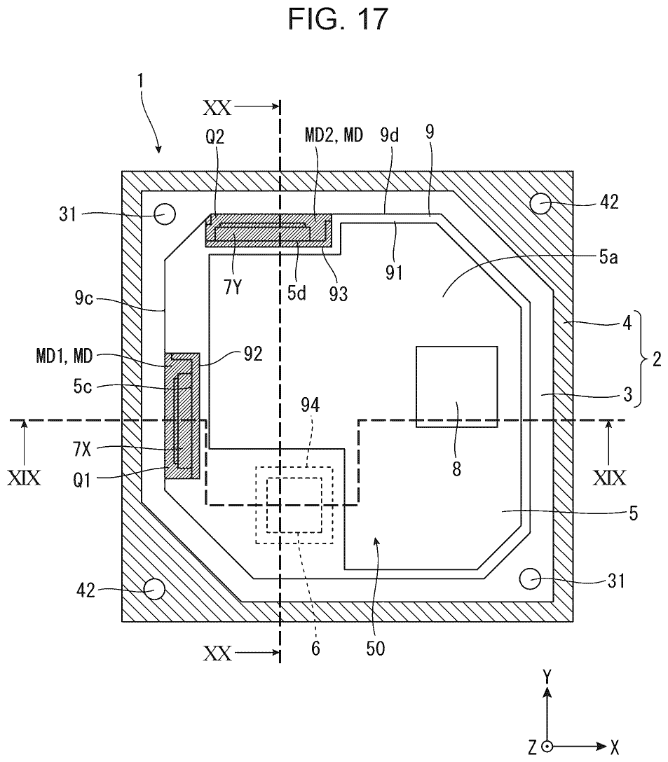

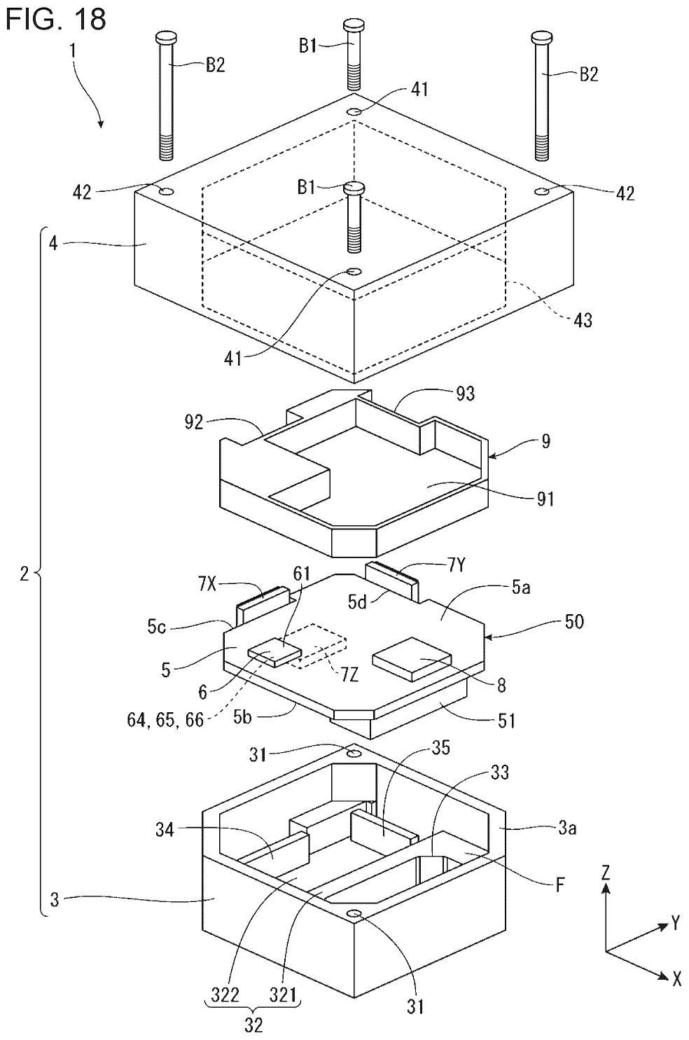

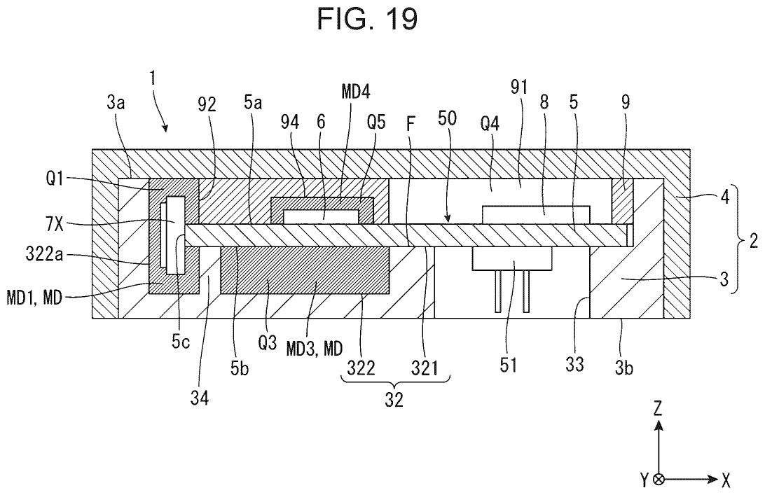

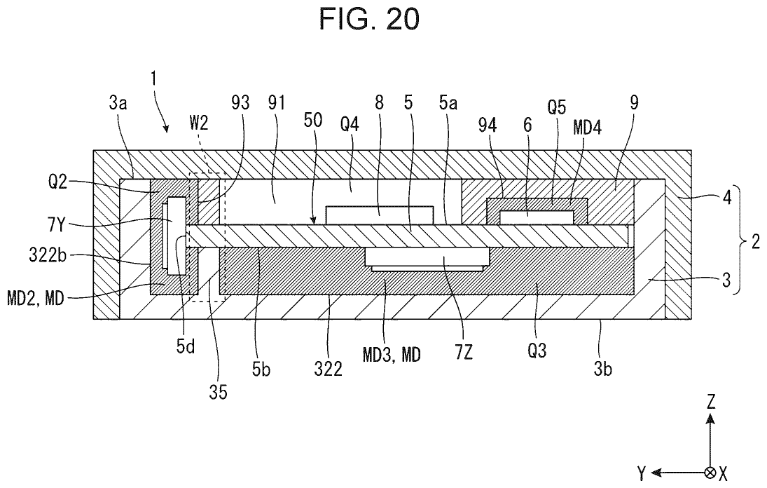

FIG. 17 is a top view illustrating an inertial measurement device according to a second embodiment. FIG. 18 is an exploded perspective view of the inertial measurement device. FIG. 19 is a cross-sectional view taken along line XIX-XIX in FIG. 17. FIG. 20 is a cross-sectional view taken along line XX-XX in FIG. 17.

The present embodiment is the same as the first embodiment described above, except that an inertial measurement device 1 further includes an acceleration sensor 6. In the following description, differences between the present embodiment and the first embodiment described above will be mainly described, and a description of the similar matters will be omitted. In addition, in each drawing of the present embodiment, the same components as those in the above-described embodiment are denoted by the same reference numerals.

### Acceleration Sensor 6

As illustrated in FIGS. 17 and 18, a sensor substrate 50 includes the acceleration sensor 6 serving as a fourth inertial sensor mounted on an upper surface 5a of a substrate 5. The acceleration sensor 6 is a three-axis acceleration sensor that can detect an acceleration in the X-axis direction, an acceleration in the Y-axis direction, and an acceleration in the Z-axis direction independently. The acceleration sensor 6 includes a package 61 and sensor elements 64, 65, and 66 housed in the package 61. The acceleration sensor 6 is electrically connected to the substrate 5 via a connection terminal (not illustrated) arranged on the package 61.

The sensor element 64 is an element that detects the acceleration in the X-axis direction, the sensor element 65 is an element that detects the acceleration in the Y-axis direction, and the sensor element 66 is an element that detects the acceleration in the Z-axis direction. The sensor elements 64, 65, and 66 are silicon MEMS vibration elements each including a fixed electrode fixed to the package 61 and a movable electrode that is movable relative to the package 61. In each of the sensor elements 64, 65, and 66, when an acceleration in a detection axis direction is received, the movable electrode is displaced relative to the fixed electrode, and a capacitance formed between the fixed electrode and the movable electrode changes accordingly. Therefore, a change in capacitance of the sensor elements 64, 65, and 66 can be extracted as a detection signal, and the acceleration in each axis direction can be obtained based on the extracted detection signal.

The acceleration sensor 6 has been described above, but a configuration of the acceleration sensor 6 is not particularly limited. For example, a quartz crystal vibration element may be used as the sensor element.

### First Partition 9

As illustrated in FIGS. 19 and 20, the first partition 9 has a recess 94 that is open on a lower surface of the first partition 9. A fifth space Q5 is formed by the substrate 5 and the recess 94. The acceleration sensor 6 is arranged in the fifth space Q5. The fifth space Q5 is filled with a fourth filling member MD4, the space Q5 having a significantly small volume surrounds the acceleration sensor 6, and a gap therebetween is filled with the fourth filling member MD4. With such a configuration, it is possible to effectively prevent intrusion of moisture and humidity into the fourth filling member MD4 around the acceleration sensor 6 and the acceleration sensor 6. In addition, for example, even when the fourth filling member MD4 absorbs moisture and expands, stress is uniformly applied to the acceleration sensor 6 from a periphery thereof, so that fluctuations in detection characteristic can be suppressed.

As described above, in the inertial measurement device 1 of the present embodiment, the sensor substrate 50 includes the acceleration sensor 6 serving as the fourth inertial sensor arranged on the upper surface 5a. The first partition 9 forms the fifth space Q5 that surrounds the acceleration sensor 6 in a case 2. The inertial measurement device 1 includes the fourth filling member MD4 that fills the fifth space Q5 and covers the acceleration sensor 6. With such a configuration, the fourth filling member MD4 can effectively prevent intrusion of moisture and humidity into the acceleration sensor 6. In addition, for example, even when the fourth filling member MD4 absorbs moisture and expands, stress is uniformly applied to the acceleration sensor 6 from a periphery thereof, so that fluctuations in detection characteristic can be suppressed.

The second embodiment can also achieve the same effect as the first embodiment. The same effect can be expected even with a structure in which the acceleration sensor 6 is arranged on the upper surface 5a and covered by a third filling member MD3 in a third space Q3 as illustrated in FIGS. 19 and 20. Furthermore, a structure in which one acceleration sensor is arranged on each of the upper surface 5a and a lower surface 5b, and the two acceleration sensors output a combined signal is applicable.

### Third Embodiment

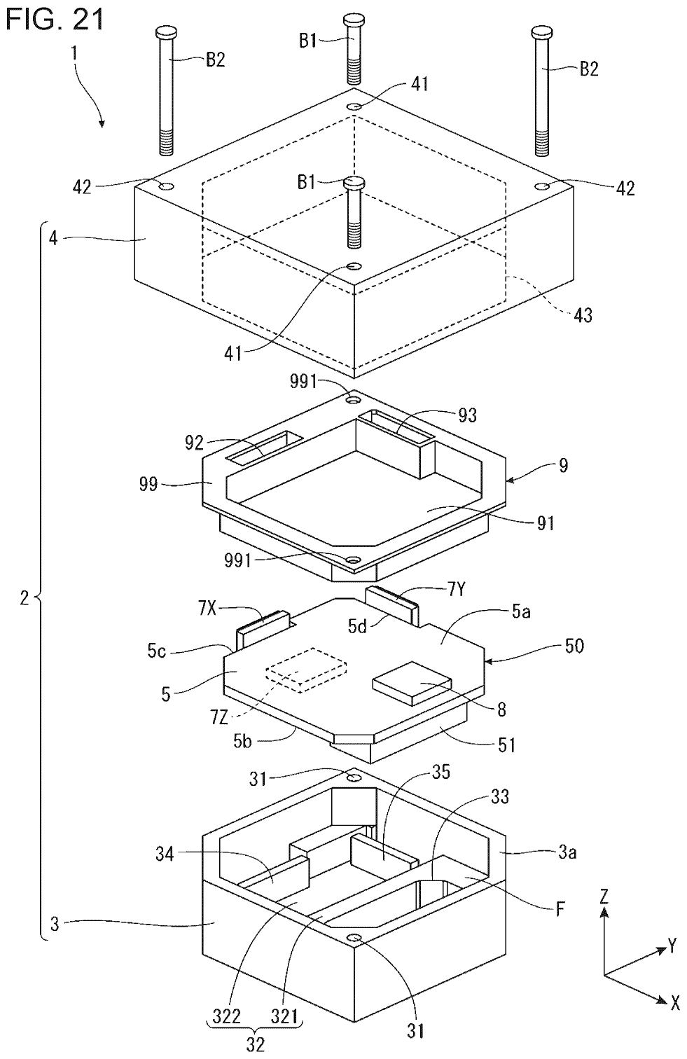

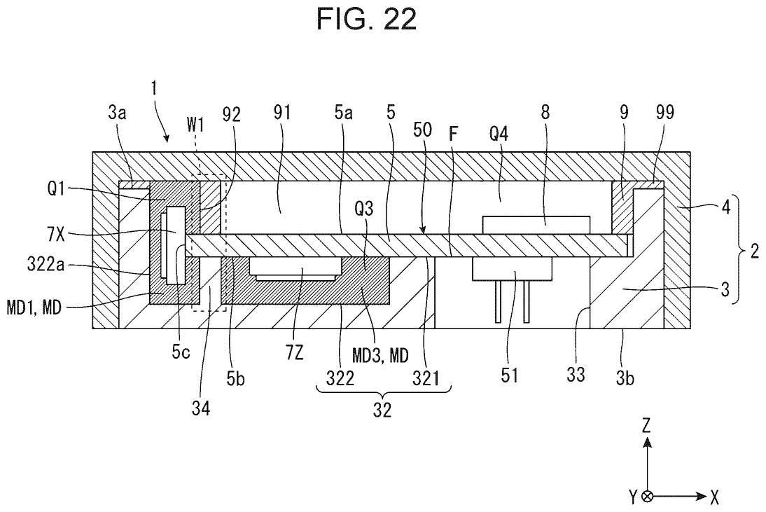

FIG. 21 is an exploded perspective view of an inertial measurement device according to a third embodiment. FIG. 22 is a cross-sectional view of the inertial measurement device. FIG. 22 is a cross-sectional view taken along line III-III in FIG. 1.

The present embodiment is similar to the first embodiment described above, except that a configuration of a first partition 9 is different. In the following description, differences between the present embodiment and the first embodiment described above will be mainly described, and a description of the similar matters will be omitted. In addition, in each drawing of the present embodiment, the same components as those in the above-described embodiment are denoted by the same reference numerals.

As illustrated in FIGS. 21 and 22, the first partition 9 of the present embodiment includes a flange portion 99 protruding laterally from an upper end portion of the first partition 9. As the flange portion 99 is mounted on an upper surface 3a of an inner case 3, the first partition 9 is positioned relative to the inner case 3. A screw hole 991 is formed in the flange portion 99 at a position that overlaps a screw hole 31 formed in the inner case 3. The first partition 9 is fixed to the inner case 3 together with an outer case 4 by being screwed together.

The third embodiment can also achieve the same effect as the first embodiment.

The inertial measurement device and the method for manufacturing the inertial measurement device according to the present disclosure have been described above based on the illustrated embodiments, but the present disclosure is not limited thereto, and a configuration of each part can be replaced with any configuration having a similar function. Any other component may be added to the present disclosure. Any process for any purpose may be added. The embodiments may also be combined as appropriate.

What is claimed is:

1. An inertial measurement device comprising:
a sensor substrate including a substrate having a first surface and a first side surface, and a first inertial sensor arranged on the first side surface;
a case housing the sensor substrate;
a first partition arranged in the case and forming a first space that surrounds the first inertial sensor in the case; and
a first filling member filling the first space and covering the first inertial sensor.

2. The inertial measurement device according to claim 1, wherein the substrate has a second surface that is in a front-back relationship with the first surface,
the inertial measurement device further comprises a second partition arranged between the second surface and the case, and
the first space is formed by the first partition, the substrate, and the second partition.

3. The inertial measurement device according to claim 2, wherein the second partition is a protrusion protruding from an inner surface of the case toward the substrate.

4. The inertial measurement device according to claim 2, wherein the substrate has a second side surface different from the first side surface,
the sensor substrate includes a second inertial sensor arranged on the second side surface,
the first partition forms a second space that surrounds the second inertial sensor, and
the inertial measurement device further comprises a second filling member filling the second space and covering the second inertial sensor.

5. The inertial measurement device according to claim 4, further comprising a third partition arranged between the second surface and the case,
wherein the second space is formed by the first partition, the substrate, and the third partition.

6. The inertial measurement device according to claim 5, wherein the third partition is a protrusion protruding from an inner surface of the case toward the substrate.

7. The inertial measurement device according to claim 5, wherein the sensor substrate includes a third inertial sensor arranged on the second surface,
the substrate, the second partition, and the third partition form a third space that surrounds the third inertial sensor in the case, and
the inertial measurement device further comprises a third filling member filling the third space and covering the third inertial sensor.

8. The inertial measurement device according to claim 7, wherein the first space, the second space, and the third space communicate with one another.

9. The inertial measurement device according to claim 1, wherein the sensor substrate includes an electronic component arranged on the first surface, and
the first partition forms a fourth space that is isolated from the first space and surrounds the electronic component in the case.

10. The inertial measurement device according to claim 1, wherein the sensor substrate includes a fourth inertial sensor arranged on the first surface,
the first partition forms a fifth space that surrounds the fourth inertial sensor in the case, and
the inertial measurement device further comprises a fourth filling member filling the fifth space and covering the fourth inertial sensor.

11. A method for manufacturing an inertial measurement device, the method comprising:
a first filling step of filling a recess of a first case with a bottom-side filling member;
a sensor substrate mounting step of mounting, in the recess, a sensor substrate including a substrate having a first surface and a first side surface and a first inertial sensor arranged on the first side surface;
a first partition arrangement step of arranging a first partition in the recess and forming a first space that surrounds the first inertial sensor in the first case;
a second filling step of filling the first space with an opening-side filling member to cover the first inertial sensor;
a filling member hardening step of hardening the bottom-side filling member and the opening-side filling member to form a first filling member that covers the first inertial sensor; and
a case attachment step of attaching a second case to the first case in such a way as to close the recess.

12. The method according to claim 11, wherein the sensor substrate includes a second inertial sensor arranged on a second side surface different from the first side surface of the substrate,
in the first partition arrangement step, the first partition is arranged to form a second space that surrounds the second inertial sensor in the first case,
in the second filling step, the second space is filled with the opening-side filling member to cover the second inertial sensor, and
in the filling member hardening step, the bottom-side filling member and the opening-side filling member are hardened to form a second filling member that covers the second inertial sensor.
